(19) United States
(12) Patent Application Publication
(10) Pub. No.: US 2012/0018066 A1
(43) Pub. Date: Jan. 26, 2012

(54) NATURAL OIL POLYOLS IN ELASTOMERS FOR TIRES

(75) Inventors: Rui Xie, Pearland, TX (US); Syed A. Shah, Grand Blanc, MI (US); Kandathil E. Verghese, Lake Jackson, TX (US)

(73) Assignee: Dow Global Technologies Inc., Midland, MI (US)

(21) Appl. No.: 13/258,925

(22) PCT Filed: Mar. 16, 2010
(86) PCT No.: PCT/US10/27458

§ 371 Date: Sep. 22, 2011

Related U.S. Application Data
(60) Provisional application No. 61/162,902, filed on Mar. 24, 2009.

(51) Int. Cl. B60C 11/00; C08G 18/10; B05D 5/00; B05D 5/10; B05D 3/12; C08G 18/42; B05D 3/00

(52) U.S. Cl. 152/209.1; 528/83; 427/331; 427/207.1; 427/355

(57) ABSTRACT

Prepolymers having active NCO groups are disclosed. The prepolymers are the reaction product of at least one polyisocyanate and a polyhydric component which comprises at least one dimer fatty derivative diol or diamine that is a natural oil based polyol or polyamine which includes the derivative of at least one dimer fatty acid. Polyurethane and polyurea elastomer obtained from the prepolymers are also disclosed. Also disclosed are methods of manufacturing polyurethane or polyurea treaded tires.

### CROSS-REFERENCE TO RELATED APPLICATIONS

This application claims benefit of U.S. Provisional Patent Application Ser. No. 61/162,902, filed Mar. 24, 2009, entitled “NATURAL OIL POLYOLS IN ELASTOMERS FOR TIRES” which is herein incorporated by reference.

### Background

### Field of the Invention

This invention is related to prepolymer compositions for use in polyurethane and polyurea elastomers wherein the polyols are at least partially derived from seed oils, and to use of such compositions in the construction of polyurethane tread of off-the-road tires.

Most polyurethane elastomer compositions in commercial use are mainly based on hydrocarbon feedstock based polyols. Thus, prices of articles made from these compositions increase with the increasing price of oil. Thus, it would be desirable to use starting materials of other than petroleum origin. There are a number of hydroxyl-terminated polyols derived from seed oils. However, polyurethane elastomers formulated using these seed oil based polyols seldom meet or exceed performance of conventional polyurethane prepolymer compositions and, therefore, are inappropriate for especially the more demanding applications such as industrial wheels, rollers, tires (sidewalls or tread), and the like. It would be desirable to meet or exceed the performance of comparable petroleum based polyols in polyurethane elastomers in terms of at least one of the engineering properties, such as abrasion resistance, tear strength, cut/puncture resistance, dynamic performance and mechanical strength. It would be especially desirable to achieve such properties sufficiently for use in applications such as tires or wheels.

### SUMMARY OF THE INVENTION

In one aspect, this invention is a prepolymer which is the reaction product of at least one polyisocyanate and a polyhydric component which comprises at least one dimer fatty derivative diol, that is a natural oil based polyol which includes the derivative of at least one dimer fatty acid.

In a second aspect, this invention includes a polyurethane or polyurea formed from a composition comprising at least one prepolymer which is the reaction product of at least one polyisocyanate and a polyhydric component which comprises at least one dimer fatty derivative diol, that is a natural oil based polyol which includes the derivative of at least one dimer fatty acid. The polyurethane or polyurea is preferably an elastomer and independently preferably has at least one of engineering properties, such as abrasion resistance, tear strength, cut/puncture resistance, dynamic performance and mechanical strength at least equal to that of a polyurethane or polyurea formed from the same composition, using the same process, except that the natural oil based polyol is replaced by a conventional polyether or polyester polyol having essentially the same molecular weight and functionality.

Further, the invention includes articles comprising at least one polyurethane or polyurea elastomer of the invention, especially where the article is at least one sidewall, tire tread, tire, wheel, rollers, automotive body part, toy, mechanical part, or insulation.

### DETAILED DESCRIPTION OF THE INVENTION

Definition of Terms:

The term “abrasion resistance” refers to resistance to abrasion as determined according to the procedures of ASTM D5963 B.

The term “tear strength” refers to resistance to tearing as determined according to the procedures of ASTM D470 or D624, Die C.

The term “dynamic performance” refers to load bearing capability of the material and heat build up in the elastomer when it is subjected to repeat deformation at a given frequency as determined by Dynamic Mechanical Analysis (DMA) at 10 HZ frequency and 2° C./min temperature incremental.

The term “tensile strength” and “elongation” refers to resistance to deformation under tension as determined according to the procedures of ASTM D412.

The term hardness refers to an empirical test of elastic modulus as measured according to the procedures of ASTM D2240.

“Glass transition temperature” (Tg) is the temperature point corresponding to the peak value of the tan delta curve in a dynamic mechanical analysis (DMA) measurement. The temperature corresponding to the peak of the tan delta curve is taken as the glass transition temperature (Tg) of the specimen tested.

The term “elastomer” is used herein to refer to a polymer which exhibits tensile elongation at break of advantageously at least about 80%, preferably at least about 120%, more preferably at least about 240%, most preferably at least about 360% and preferably at most about 2000%, more preferably at most about 1000%, and, in some embodiments, most preferably at most about 800% percent as measured by the procedures of ASTM D-412 and/or D-882.

The term “elongation” as applied to a polymer not in the form of a foam is used herein to refer to the percentage that the material specified can stretch (extension) without breaking and is tested in accordance with the procedures of ASTM D412.

The term “polyurethane” is used to designate a polymer whose structure contains predominately urethane linkages between repeating units. Such linkages are formed by the addition reaction between an organic isocyanate group R—[—NCO] and an organic hydroxyl group [HO—]—R. In order to form a polymer, the organic isocyanate and hydroxyl group-containing compounds must be at least difunctional. However, as modernly understood, the term “polyurethane” is not limited to those polymers containing only urethane linkages, but includes polymers containing minor amounts of allophanate, biuret, carbodiimide, oxazolinyl, isocyanurate, uretidinedione, urea, and other linkages in addition to urethane. The reactions of isocyanates which lead to these types of linkages are summarized in the “POLYURETHANE HANDBOOK”, Gunter Oertel, Ed., Hanser Publishers, Munich, ®1985, in Chapter 2, p. 7-41; and in “POLYURETHANES: CHEMISTRY AND TECHNOLOGY”, J. H. Saunders and K. C. Frisch, Interscience Publishers, New York, 1963, Chapter III, pp. 63-118.

The term “polyurea” is used to designate a polymer whose structure contains at least one urea linkage between repeating units. Such linkages are formed by the addition reaction between an organic isocyanate group R—[—NCO] and an organic amine group [H₂N—]—R. In order to form a polymer, the organic isocyanate and amine group-containing compounds must be at least difunctional. However, as modernly understood, the term “polyurea” is not limited to those polymers containing only urea linkages, but includes polymers containing minor amounts of allophanate, biuret, carbodiimide, oxazolinyl, isocyanurate, uretidinedione, and other linkages in addition to urethane.

The term “prepolymer” is used to designate a reaction product of polyisocyanates which has at least two reactive functional groups to react with a isocyanate reactive component having an average functionality greater than 1.8. In the practice of the present invention, the prepolymer preferably has remaining reactive isocyanate groups. Independently, it is preferably a reaction product of at least one polyisocyanate and at least one polyol or polyamine.

The term “soft segments” as used herein refers to that portion of a polyurethane and polyurea that comes from polyols or polyamines having an average molecular weight of at least about 350. These segments are observed to enable deformation, while maintaining cohesion of the polymer and increasing ultimate elongation. The amount of soft segments is estimated by calculation of ratio of weight of polyols or polyamines having an average molecular weight of at least 350 to total polymer weight. The true soft phase is often lower than this ratio due to phase mixing that may occur with hard phase. This phase mixing is more favored at lower polyol and polyamine molecular weight and higher polyol and polyamine functionalities.

The term “hard segments” as used herein refers to that portion of a polyurethane and polyurea formed between the chain extender and the di- or polyisocyanate. The hard segment is observed to provide resistance to deformation, increasing polymer modulus and ultimate strength. An amount of hard segments is estimated by calculation of ratio of weight of di- or poly-isocyante and chain extender to total polymer weight.

The term “dimer fatty acid” is used herein to designate products having the dimerization product of one or more mono- or poly-unsaturated fatty acids as the principal constituent thereof. Dimer fatty acids are well known in the polymer art. They typically exist as mixtures. For example, dimer fatty acids normally contain a percentage of trimer fatty acids and a relatively small percentage of monofunctional fatty acids. Dimer fatty acids, which are suitable for the purposes of the invention, are those containing from about 0 to about 20 mole percent of trimer fatty acids. GB-2203425-A is directed to dimerized fatty acids and describes forming polyesters using such dimerized fatty acids. The polyesters produced according to the teaching of GB-2203425-A are homo polyesters or random copolyesters.

The term “dimer fatty acid diol”, “dimer fatty diol” or “dimer diol” is used herein to designate a diol prepared from at least one dimer fatty acid or derivative thereof, preferably from the acid or ester or a combination thereof.

The term “dimer fatty acid derivative diol”, “dimer fatty derivative diol”, “derivative fatty diol” or “derivative diol” is used herein to designate a diol prepared from at least one dimer fatty acid or derivative thereof, preferably from the dimer fatty acid or ester thereof, from a dimer fatty acid diol or a combination thereof. Thus, the term dimer fatty acid derivative diol also includes a dimer fatty acid diol unless stated otherwise.

The term “Initiator” is used to mean a compound having at least one “active hydrogen group” that is, at least one functional group having a hydrogen atom on an atom such as oxygen, sulfur or nitrogen, which is sufficiently active to react with an alkylene oxide or a carboxylic acid. Initiators include such compounds as, water, ethylene glycol, diethylene glycol (DEG), neopentyl glycol (NPG), 1,4 butanediol (BDO), 1,6 hexanediol, trimethylolpropane (TMP), or propylene glycol, glycerol, sorbitol or combinations thereof.

As used herein, “polyol” refers to an organic molecule having an average of greater than 1.0 hydroxyl groups per molecule. It may also include other functionalities, that is, other types of functional groups.

As used herein, “polyamine” refers to an organic molecule having an average of greater than 1.0 amine groups per molecule. It may also include other functionalities, that is, other types of functional groups.

The term “polyether polyol” is used herein to designate a reaction product of an initiator and at least one alkylene oxide, for instance ethylene oxide (EO), propylene oxide (PO), butylene oxide (BO) and the like or combination thereof, where the combination is optionally sequential or simultaneous.

The term “natural oil” is used herein to refer to animal and vegetable oils, preferably vegetable oils. Examples of vegetable and animal oils include, but are not limited to, castor oil, soybean oil, safflower oil, linseed oil, corn oil, sunflower oil, olive oil, canola oil, sesame oil, cottonseed oil, palm oil, rapeseed oil, tung oil, fish oil, or a blend of any of these oils. For purposes of this invention, petroleum or mineral oils are distinguished from natural oils.

The term “natural oil or derivative thereof” is used herein to refer to a natural oil as previously discussed or any substance, compound or combination thereof chemically or physically, preferably chemically, derivable from a natural oil. Multiple chemical reactions are optionally required.

The term “natural oil moiety” is used herein to refer to a molecule or, preferably, a part of a molecule which is derived from or derivable from a natural oil. The moiety is optionally derivable from an entire oil molecule such as castor oil or from a portion of an oil molecule such as from a fatty acid. It is optionally in the form obtained from the natural source, such as castor oil, or is the result of one or more chemical or physical processes on a natural oil or portion thereof, for instance a fatty acid.

As used herein the term “structural element” means a portion of a molecule comprising at least two atoms bonded to each other within the structural element and at least one atom bonded to at least one other structural atom in the molecule. The structural element preferably retains structural characteristics, at least structural skeleton of its chemical source. Thus, in an ester formed between one polyether polyol having a chemical formula HORORORZ and one fatty acid of the chemical formula HOOCR′CHOHR″ (wherein R, R′, R″ are saturated or unsaturated hydrocarbon groups of C2 to C18, and Z is the remainder of the polyether polyol usually derived from the initiator from which the polyol is formed), which ester has the structure ZROROROOCR′CHOHR″, the structural element derived from the polyether polyol is ZROROR— and the structural element derived from the fatty acid or natural oil from which the fatty acid was separated is —OCR′CHOHR″.

The term “renewable resource” is used herein to refer to annually renewable resources such as compounds of animal and plant origin as distinguished from, for instance, petroleum or mineral oils and derivatives.

The terms “natural oil content,” “weight contribution of renewable resource,” “renewable resource content,” “renewable content”, and “weight contribution from natural oil” all refer to that weight percentage of the subject matter derived from plant or animal oil or fat as its origin. For instance, if a vegetable oil with a molecular weight of 1000 and having 3 hydroxyl groups is reacted with a trifunctional polyether polyol molecule of other than plant or animal oil origin with a molecular weight of 290 to make a triol, with removal of glycerin which has a molecular weight of 90, the weight contribution of renewable resource is (1000−90)/(1000−90+290)=76 percent.

The term “functionality”, “OH functionality”, “hydroxyl functionality”, “polyol functionality”, “amine functionality”, or “polyamine functionality” is used herein to refer to the number of hydroxyl groups or amine groups in a polyol or a polyamine unless other functional groups are particularly identified.

The term “hydroxyl number” indicates the concentration of hydroxyl moieties in a composition of polymers, particularly polyols. A hydroxyl number represents mg KOH/g of polyol. A hydroxyl number is determined by acetylation with pyridine and acetic anhydride in which the result is obtained as the difference between two titrations with KOH solution. A hydroxyl number may thus be defined as the weight of KOH in milligrams that will neutralize the acetic anhydride capable of combining by acetylation with 1 gram of a polyol. A higher hydroxyl number indicates a higher concentration of hydroxyl moieties within a composition. A description of how to determine the hydroxyl number for a composition can be found in texts well-known in the art, for example in Woods, G., “The ICI Polyurethanes Book”—2nd ed. (ICI Polyurethanes, Netherlands, 1990).

The term “natural oil polyol” (hereinafter NOP) is used herein to refer to compounds having hydroxyl groups which compounds are isolated from, derived from or manufactured from natural oils, including animal and vegetable oils, preferably vegetable oils. Examples of vegetable and animal oils that may be used include, but are not limited to, soybean oil, safflower oil, linseed oil, corn oil, sunflower oil, olive oil, canola oil, sesame oil, cottonseed oil, palm oil, rapeseed oil, tung oil, fish oil, or a blend of any of these oils. Alternatively, any partially hydrogenated or epoxidized natural oil or genetically modified natural oil can be used to obtain the desired hydroxyl content. Examples of such oils include, but are not limited to, high oleic safflower oil, high oleic soybean oil, high oleic peanut oil, high oleic sunflower oil (such as NuSun sunflower oil), high oleic canola oil, and high oleic rapeseed oil (such as Crumbe oil). Natural oil polyols are well within the knowledge of those skilled in the art, for instance as disclosed in Colvin et al., UTECH Asia, “Low Cost Polyols from Natural Oils”, Paper 36, 1995 and “Renewable raw materials—an important basis for urethane chemistry” in Urethane Technology: vol. 14, No. 2, April/May 1997, Crain Communications 1997, WO 2001/04225, WO 2004/096882; WO 2004/096883; U.S. Pat. No. 6,686,435, U.S. Pat. No. 6,433,121, U.S. Pat. No. 4,508,853, U.S. Pat. No. 6,107,403, US Pregrant publications 2006/0041157, and 2004/0242910. For purposes of this invention, petroleum oils are distinguished from natural oils.

The term “natural oil based polyol” is used herein to refer to natural oil polyol compounds which are derived from natural oils. For instance, natural oils or isolates therefrom are reacted with compounds ranging from air or oxygen to organic compounds including amines and alcohols. Frequently, unsaturation in the natural oil is converted to hydroxyl groups or to a group which can subsequently be reacted with a compound that has hydroxyl groups such that a polyol is obtained. Such reactions are discussed in the references in the preceding paragraph.

As used herein the term “conventional polyol” is any polyol within the skill in the art commonly used in the formation of polyurethane or urea polymers. Conventional polyether polyols are formed from at least one alkylene oxide, preferably ethylene oxide, propylene oxide or a combination thereof, and not having a part of the molecule derived from a vegetable or animal oil, a polyol of the type commonly used in making polyurethane foams, particularly for the practice of this invention, HR (high resilience) polyurethane foams. Polyether polyols are prepared by methods within the skill in the art such as by alkoxylation of suitable starter molecules. Such a method generally involves reacting an initiator such as, water, ethylene glycol, or propylene glycol, glycerol, sorbitol or blends thereof with an alkylene oxide in the presence of a catalyst. Ethylene oxide, propylene oxide, butylene oxide, or a combination of these oxides can be particularly useful for the alkoxylation reaction. A polyether polyol, for instance polyoxyethylene polyol can contain alkyl substituents. The process for producing polyether polyols can involve a heterogeneous feed of a mixture of alkylene oxides, a sequential feed of pure or nearly pure alkylene oxide polyols to produce a polyol with blocks of single components, or a polyol which is capped with, for example, ethylene oxide or propylene oxide. Other types of conventional polyols include polyester polyols, polybutadiene polyols, polyether siloxane polyols, poly tetrahydrofuran polyols and combinations thereof. These types of polyols are all known and used in polyurethane chemistry.

The term “NCO Index” means isocyanate index, as that term is commonly used in the polyurethane art. As used herein as the equivalents of isocyanate, divided by the total equivalents of isocyanate-reactive hydrogen containing materials, multiplied by 100. Considered in another way, it is the ratio of isocyanate-groups over isocyanate-reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

In the present invention at least one dimer fatty derivative diol is reacted with at least one polyisocyanate to form a prepolymer.

The dimer fatty derivative diol is a diol prepared from at least one dimer fatty acid or ester thereof or a dimer fatty diol. The dimer fatty acid or ester is suitably reacted by any means within the skill in the art of chemical reactions (conversions) to form a diol, for instance reduced from the acid or ester to the corresponding alcohol, esterified or transesterified to form an ester having at least one, preferably one, hydroxyl group on each alcohol component of the ester. The alcohol component is that portion of an ester molecule originating from the alcohol or derivative thereof that is reacted with the acid component of an ester, where the acid component is that molecular portion originating nominally from the acid or derivative thereof in the formation of an ester from an alcohol and an acid or derivatives of each. In other words, the acid component is attached to and includes the carboxyl group or carbon oxygen double bond of the ester while the alcohol component is attached to and includes the oxygen atom attached to the carboxyl group and the carbon single bonded to that oxygen atom. Optionally, a dimer fatty diol is formed and a subsequent diol derivative of it formed, for instance by oligomerization.

When used, a dimer fatty diol is formed, for instance, by reduction of the carboxyl groups of a dimer acid (that is, each carboxyl functionality is chemically transformed into a hydroxyl group). Alternatively, a dimer diol could be made by first converting the carboxyl groups of a long chain aliphatic acid to hydroxyl groups and then performing the dimerization process. Preferably the dimer diol is formed by hydrogenation of the corresponding dimer fatty acid or mixture thereof. Since the dimer fatty diol is prepared from at least one dimer fatty acid, preferences in dimer fatty diol compositions are discussed in terms of preferences in the starting dimer fatty acids.

Dimer fatty acids are well known in the polymer art and are commercially available. They comprise dimerization products of one or more poly- or, preferably, mono-unsaturated aliphatic monocarboxylic fatty acids, usually of 13 to 22 carbon atoms, or their esters (e.g. alkyl esters) as the principal constituent thereof. The dimerization is thought by those in the art (although we should not be bound by this) to proceed by possible mechanisms which includes Diels Alder, free radical, and carbonium ion mechanisms.

Dimer fatty acids typically exist as mixtures. For example, dimer fatty acids normally contain a percentage of oligomeric fatty acids referred to as trimer fatty acids and a relatively small percentage of monofunctional fatty acids, which are the residue of the fatty acids dimerized, which acids are optionally present as esters. The amount of monomer can, for example, be reduced by distillation. Several different grades of dimer acids are available from commercial sources and these differ from each other primarily in the amount of monobasic and trimer acid fractions and the degree of unsaturation. Preferred dimer fatty acids, used to form a polyurethane according to the present invention, have a dicarboxylic (or dimer) content of at least about 45, advantageously at least about 60, more advantageously at least about 70, and most advantageously at least about 75, preferably at least about 95, more preferably at least about 97.5, particularly at least about 98.5, and especially at least about 99.0 percent by weight. The trimer content is advantageously at most about 55, preferably at most about 40, more preferably at most about 30, and most preferably at most about 25 percent by weight. The monomer content is preferably at most about 10, more preferably at most about 5, most preferably at most about 4, and especially at most about 3 percent by weight. All of the percent by weight values are based on the total weight of trimer, dimer and monomer present.

Unless otherwise stated or implied from the context, the term “dimer acid” or “dimer fatty acid” is used herein to collectively convey both the diacid material itself, or ester-forming derivatives thereof (such as lower alky esters) which would act as an acid component in polyester synthesis and includes (if present) any trimer or monomer.

Preferred dimer acids are dimers of C10 to C30, more preferably C12 to C24, most preferably C14 to C22, and especially C18 alkyl chains. Consequently, preferred dimer acids comprise in the range from 20 to 60, more preferably 24 to 48, most preferably 26 to 44, and especially 36 or 44, most preferably 36 carbon atoms. Suitable dimer fatty acids include the dimerization products of oleic acid, linoleic acid, linolenic acid, palmitoleic acid, elaidic acid, or erucic acid. The dimerization products of any unsaturated fatty acid mixtures obtained in the hydrolysis of natural fats and oils are useful, for instance, sunflower oil, soybean oil, olive oil, rapeseed oil, cottonseed oil, tall oil, and combinations thereof.

The most preferred dimer acids derived from C-18 unsaturated acids, which include acids such as linoleic and linolenic are particularly well known (yielding C-36 dimer acids). For example DELTA 9, 11 and DELTA 9, 12 linoleic acids can dimerize to a cyclic unsaturated structure (although this is only one possible structure; other structures, including acyclic structures are also possible). Processes for forming this acid are well known and form the subject of numerous U.S. patents including U.S. Pat. Nos. 2,482,761, 2,793,220, 2,793,221 and 2,955,121. In carrying out said dimer-forming operations, unsaturated fatty acids such as oleic, linoleic and linolenic acid, or mixtures of such acids (usually admixed with saturated fatty acids), all of essentially C18 chain length, are heated in the presence of water, or in the presence of both water and an active clay mineral, to induce polymerization. The polymeric fatty acid reaction mixtures so prepared often contain from about 30 to 75 percent by weight of acid polymer, with the balance of the mixture representing C18 monocarboxylic (monomer) acids of one type or another which are preferably distilled from the mixture once the polymerization operation is concluded. The residual polymer fraction consists substantially of dimer (C36 dicarboxylic acids) together with amounts up to about 20 or 22 weight percent of C54 trimer. However, the trade customarily refers to this dimer-trimer mixture as “dimer”, and this practice is followed herein. The preferred grade contains at least 97 weight percent dimer and at most 3 weight percent trimer.

Usually the dimer acid (or ester) products as initially formed are unsaturated which could possibly be detrimental to their oxidative stability by providing sites for crosslinking or degradation, and so resulting in changes in the physical properties of the resulting product. It is therefore preferable (although not essential) to use dimer acid products which have been hydrogenated to remove a substantial proportion of the unreacted double bonds.

In one preferred embodiment, at least one dimer fatty acid, at least one dimer fatty diol or a combination thereof is optionally reacted with at least one other compound to form a polyester polyol, also referred to hereinafter as “dimer polyester polyol” or “dimer polyol” by methods within the skill in the art, for instance as described in U.S. Pat. No. 4,423,179, U.S. Pat. No. 5,416,880, US 2005/0143549 or US2005/0124711, which are hereby incorporated herein by reference, especially with respect to the constituents of and formation of polyesters, to the fullest extent permitted by law. Thus, the acid-component, hydroxyl or alcohol component, or both residues of the polyester polyol are at least partially comprised of dimer acid residues, in the case of the acid-component being derived from a dimer acid and in the case of the hydroxyl component being derived from the diol derivative of a dimer acid.

The amount of dimer acid residues to incorporate in the polyester polyol will depend on the desired nature and properties of the resulting polyester polyol in relation to the resulting polyurethane product and its intended application. In most instances, however, the amount of dimer acid residues incorporated will correspond to a level of dimer acid-based reactants (that is, the dimer acid, dimer diol or combination thereof reactants used in the polyester synthesis) which is preferably at least about 30, more preferably at least about 50, and independently most preferably at most about 100 weight percent, sometimes preferably at most about 90 weight percent, based on the total of acid and hydroxyl component reactants employed in the polyester polyol synthesis.

When the polyester polyol is synthesized using at least one dimer acid as the acid component of the polyester, that component optionally consists solely or essentially of dimer acid, that is the dimer acid can be the only acid in the acid component. Alternatively, the dimer acid is used in conjunction with (that is copolymerized with) any one or more non-dimer diacids or higher functionality acids (or their ester forming derivatives) which are known to be useful in the synthesis of polyesters. Suitable acids for this purpose include C4 to C20 aliphatic, alicyclic and aromatic dicarboxylic acids (or higher functionality acids) or their ester-forming derivatives (such as anhydrides or lower alkyl esters), preferably having a carbon chain of at least about 2, more preferably at least about 6 and independently preferably at most about 20, more preferably at most about 12 carbon atoms and most preferably having terminal carboxyl groups. Specific examples include adipic acid, fumaric acid, maleic acid, succinic acid, itaconic acid, sebacic acid, glutaric acid, pimelic acid, azelaic acid, sebacic acid, heptane dicarboxylic acid, octane dicarboxylic acid, nonane dicarboxylic acid, decane dicarboxylic acid, undecane dicarboxylic acid, dodecane dicarboxylic acid and higher homologs thereof, 1,4-cyclohexanedicarboxylic acid, 1,3-cyclohexanedicarboxylic acid, 1,2-cyclohexanedicarboxylic acid, terephthalic acid, isophthalic acid, phthalic acid, and tetrahydrophthalic acid. Anhydrides include succinic, maleic and phthalic anhydrides.

The hydroxyl component reactants used in the polyester polyol synthesis with at least one dimer acid component, are optionally any one or more of the dimer diols or non dimer diols (glycols) known to be useful for polyester synthesis or a combination thereof. Non-dimer diols, which preferred in one embodiment, are optionally used, if desired, (for instance, tri-or tetrafunctional alcohols). Examples of the non-dimer diols include 1,6-hexane diol, ethylene or propylene glycol, diethylene glycol, 1,3-propylene glycol, dipropylene glycol, 1,4-butanediol, 1,6-hexylene glycol, neopentyl glycol, 3-methyl pentane glycol, 1,2-propylene glycol, the 1,2-,1,3-, and 1,4-cyclohexanediols and the corresponding cyclohexane dimethanols, 1,4:3,6 dianhydrohexitol, glycerol, trimethylol propane, pentaerythritol and combinations thereof. Diols such as alkoxylated bisphenol A products (which are included within the term aralkyl glycols), for instance ethoxylated or propoxylated bisphenol A are optionally used when a rather higher Tg polyurethane material is desired. Other useful diols include such diols as caprolactone diol (that is, the reaction product of caprolactone and ethylene glycol), and polyether glycols, for instance, poly (oxytetramethylene) glycol.

In one embodiment, diethylene glycol is a particularly preferred diol. In the case of reaction with at least one dimer fatty acid, the other compound preferably is a diol having an aliphatic linear or cyclic carbon chain comprising in the range from 1 to 10, more preferably 3 to 6 carbon atoms.

In the synthesis of the polyester polyol using at least one dimer diol, the hydroxyl- or alcohol-component optionally consists solely or essentially of dimer diol. Alternatively the dimer diol is optionally used in conjunction with (that is copolymerized with) any one or more of the non dimer diols (or higher functionality alcohols) known to be useful for polyester synthesis, examples of which are given previously when discussing the hydroxyl-component reactants used with a dimer acid component. The acid component reactants used in the polyester polyol synthesis with at least one dimer diol includes any one or more of the dimer or non-dimer diacids or higher functionality acids which are known to be useful in the synthesis of polyesters, examples of which those previously listed as acid component reactants optionally used with a dimer acid component.

In one preferred embodiment, the acid-component of the dimer polyester polyol comprises (consists solely, essentially or partially of) at least one dimer acid, while the hydroxyl component comprises (consists solely, essentially or partially of) at least one dimer diol. Examples of acid and alcohol components optionally used with the dimer acid and dimer diol are those previously listed.

The relative amounts of the acid component reactants and hydroxyl-component reactants should be such that the resulting dimer polyester polyol is hydroxyl-terminated, preferably a diol. Therefore a stoichiometric excess of hydroxyl components is used. Often, the reactants are usually used in proportions such that the ratio of hydroxyl component, hydroxyl groups to acid component, carboxyl groups is preferably at least about 1.05:1, more preferably at least about 1.3:1 and independently at most about 1.5:1, more preferably at most about 1.1:1.

The number average molecular weight of the dimer polyester polyol will often be advantageously at least about 250, preferably at least about 1000, more preferably at least about 1500, most preferably at least about 2000, and independently advantageously at most about 5000, preferably at most about 4000, more preferably at most about 3000, and most preferably at most about 2000.

Preferable properties are often obtained by using a dimer polyester polyol having an average functionality of at least about 2. The polyester polyol in one preferred embodiment consists essentially of at least one diol with up to about 25 mole percent of a multi-functional alcohol having 3 or more hydroxyl groups. The higher functional polyester polyol is formed, for instance, by reacting at least one dimer acid with a hydroxy component comprising at least a portion of triol or higher multi-functional alcohol. While some branching is desirable for some end uses, the polyester polyol should not be highly branched. There may also be present a small amount of monoalcohol, particularly if larger proportions of higher functional alcohols are used. Such higher functional alcohols can include, for example, trimethylolpropane, trimethylolethane, pentaerythritol, and the like, as well as higher molecular weight polyols such as those produced by oxyalkylating lower molecular weight polyols.

The number of hydroxyls present in the polyester polyol can be varied, but it is preferred that its hydroxyl value as determined by ASTM designation E-222-67, Method B, be at least about 20 and more preferably at least about 40 most preferably at least about 50 and independently at most about 225, more preferably at most about 110, most preferably at most about 56.

Dimer fatty acids and derivatives thereof are commercially available, for instance from Uniqema, ICI Americas, Inc., ICI Uniqema, Inc., or Mona Industries. under the trade names Pripol™ and Priplast™, including such materials as Priplast 3192, Priplast 3172, Priplast 3162, Priplast 3191, Priplast 3195, Priplast 1838, Priplast 3196, Priplast 3197, Priplast 3198, Priplast 3190, Pripol 2300, Pripol 1040, Priplast 3900, Priplast 3920, and the like.

At least one dimer fatty acid derivative diol, preferably diol derivative of at least one dimer fatty acid or dimer fatty diol, more preferably dimer polyester polyol or diol, most preferably dimer polyester polyol or diol produced using at least one dimer fatty acid or derivative thereof in the acid component thereof, as previously described, provides the major portion of the polyhydric composition reacted with at least one polyisocyanate to form a prepolymer according to the practice of the invention and preferably makes up at least about 25%, more preferably at least about 50%, most preferably the entire polyhydric component utilized in the preparation of the prepolymer. Thus, in some alternative embodiments, other hydroxyl containing compounds are also used with the dimer fatty acid derivative diol. Polyhydric materials used are of any molecular weight, or a combination of molecular weights, for instance the diols previously listed for reaction with the dimer fatty acid derivative acid component, 1,4 butanediol, ethylene glycol, trimethlolpropane, diethylene glycol, neopentyl glycol, propylene glycol, 1,6-hexanediol or combinations thereof.

Polyisocyanates is any organic compound having an average of more than one isocyanate group, or combination of such compounds. Polyisocyanates include hydrocarbon diisocyanates or substituted hydrocarbon diisocyanates, such as p-phenylene diisocyanate (PPDI), biphenyl 4,4′ diisocyanate, toluene diisocyanate (TDI), 3,3′-dimethyl-4,4 biphenylene diisocyanate, 1,4-tetramethylene diisocyanate, 1,6-hexamethylene diisocyanate (HDI), 2,2,4-trimethylhexane-1,6 diisocyanate, methylene bis (phenyl isocyanate) (MDI), 1,5 naphthalene diisocyanate(NDI), tolidene disiocyanate (TODI), cyclohexanediisocyanate (CHDI), bis(isocyanatomethyl)cyclohexane, bis (isocyanatoethyl fumarate), isophorone diisocyanate (IPDI), methylene-bis-(4 cyclohexylisocyanate), isocyanate-terminated adducts of diols, such as ethylene glycol, 1,4-butylene glycol, polyalkylene glycols, and the like, isocyanate dimers and trimers, such as polyisocyanate of hexamethylene diisocyanate, bis(isocyanatomethyl)cyclohexane and the like. These are formed by reacting more than one mole of a diisocyanate, such as those mentioned, with one mole of a diol to form a longer chain diisocyanate. Alternatively, the diol is added along with the diisocyanate. While diisocyanates are preferred, other multi-functional isocyanates can be utilized. Examples are 1,2,4-benzene triisocyanate and polymethylene polyphenyl isocyanate (PMDI). Mixtures of the polyisocyanates are optionally used. Preferred polyisocyanates include TDI, MDI, PPDI, NDI, TODI, CHDI, H12MDI, HDI, HDI dimer, HDI trimer, or a combination thereof.

The proportions of the polyisocyanate and the polyhydric component comprising at least one dimer fatty acid derivative diol are chosen to provide an Isocyanate terminated prepolymer product. This can be accomplished by using excess stoichiometric amount of polyisocyanate, that is, more than one isocyanate group per active hydrogen group, preferably hydroxyl, amine and unreacted carboxyl group of the polyhydric component. The ratio of isocyanate groups to active hydrogen, more preferably hydroxyl and amine groups, on the polyhydric component comprising at least one dimer fatty acid derivative diol or diamine is preferably at least about 1.5, more preferably at least about 1.7, most preferably at least about 1.8, and independently preferably at most about 10, more preferably at most about 6, most preferably at most about 3. Higher (that is stoichiometric amounts or excess) isocyanate levels are optionally used.

Reaction of the polyhydric component containing at least one dimer fatty acid derivative diol or diamine with the polyisocyanate can be catalyzed using at least one catalyst within the skill in the art for such reactions. Examples of urethane catalysts include tertiary amines such as triethylamine, 1,4-diazabicyclo[2.2.2.]octane (DABCO), N-methylmorpholine, N-ethylmorpholine, N,N,N′,N′-tetramethylhexamethylenediamine, 1,2-dimethylimidazol; and tin compounds such as tin(II)acetate, tin(II)octanoate, tin(II)laurate, dibutyltin dilaurate, dibutyltin dimaleate, dioctyltin diacetate and dibutyltin dichloride. The catalysts are optionally used alone or as mixtures thereof. The reaction is preferably taken place at temperature between 60° C. and 80° C., and usually takes 4-6 hours to complete as taught in prior arts.

To form a polyurethane or polyurea, the resulting prepolymer is further reacted with at least one chain extender. Suitable chain extenders include those listed for use in making the polyurethane or polyurea elastomers, preferably aliphatic diols and aromatic diamines. Suitable aliphatice diols for use herein include, but not limited to, 1,4-butanediol (BDO), di (beta-hydroxyethyl) ether (HER), di(beta-hydroxypropyl) ether (HPR), hydroquinone-bis-hydroxyethyl ether (HQEE), 1,3-propanediol, ethylene glycol, 1,6-hexanediol, 1,4-cyclohexane dimethanol and the like and combinations thereof. Sutable aromatic diamines for use herein include, but not limited to, 4,4′-methylene-bis(3-chloroaniline) (MBCA), 4,4-methylene-bis(3-chloro-2,6-diethylaniline) (MCDEA), 4,4′-methylene-bis(2,6-diethylaniline) (MDEA), diethyl toluene diamine (DETDA, Ethacure™ 100 from Albemarle Corporation), tertiary butyl toluene diamine (TBTDA), dimethylthio-toluene diamine (Ethacure™ 300 from Albemarle Corporation), trimethylene glycol di-p-amino-benzoate (Vobracure® A157 from Chemtura Corporation or Versalink® 740M from Air Products and Chemicals), methylenedianiline (MDA) and methylenedianiline-sodium chloride complex (Caytur® 21 and 31 from Chemtura Corporation). If desired, aliphatic triols and tetrols, such as trimethylol propane, and adducts of propylene oxide, and/or ethylene oxide having molecular weight 190 to 500, such as various grades of vanol (Dow Chemical), Pluracol (BASF Corporation), and Quadrol (BASF Corporation), and aliphatic secondary amines, such as Polyclear 136 (Bayer Corporation), Jefflink 754 diamine (Huntsman Coporation), Clearlink 1000 (UOP Corporation), Ethacure SD-10 (Albemarle Corporation) and the like or a combination thereof can be also used.

The proportions of the prepolymer and chain extender are chosen to provide a polyurethane or polyurea product, preferably having essentially all isocyanate groups and active hydrogen groups reacted. This can be accomplished by using approximately a stoichiometric amount of polyisocyanate to chain extender, that is, one isocyanate group per active hydrogen. The ratio of isocyanate groups to active hydrogen, preferably hydroxyl and amine groups, of the chain extenders is preferably at least about 0.90, more preferably at least about 1.0, most preferably at least about 1.05, and independently preferably at most about 1.10.

The resulting polyurethane, because of the use of the dimer fatty acid derivative, is at least partially comprised of natural oil based or renewable materials. The renewable content is thus, preferably at least about 1.0%, more preferably at least about 5.0%, most preferably at least about 10.0% weight percent renewable content.

The polyurethane resulting from the reaction of at least one chain extender with at least one prepolymer, which is a reaction product of at least one polyisocyanate with a polyhydric component comprising at least one dimer fatty acid derivative diol is preferably an elastomer. It preferably has at least one, and preferably more with increasing preference for increasing numbers of equivalent or superior properties of abrasion resistance, tear strength, cut/puncture resistance, dynamic performance and mechanical strength that is at least equal to, and preferably more than, that of a polyurethane prepared in the same manner using the same chain extender or combination thereof, but using a prepolymer wherein the dimer fatty acid derivative diol or combination thereof is replaced by at least one petroleum based polyol having essentially the same molecular weight and functionality.

The resulting polyurethanes are useful in applications wherein such properties are useful such as tires and wheels. Preferably, the polyurethanes are useful in at least one sidewall, tire tread, tire, industrial wheel, roller, recreation wheel, sport goods, automotive body part, toy, mechanical part, or insulation.

In each of the uses, polyurethanes of the invention are used as polyurethanes produced from petroleum based starting materials, optionally with modifications that are within the skill in the various arts appropriate to the uses. For instance, polyurethanes of the invention are optionally used in end uses as described in such references as “Polyurethane Handbook” by Gunter Oertel and “Azycher's Handbook of Polyurethane” by Michael Szycher which illustrate the skill in the art and are incorporated herein by reference to the extent permitted by law. The polyurethanes are, for instance, formulated with additives such as UV stabilizers, moisture scavengers, color pigments, and air releasers or combinations thereof.

Objects and advantages of this invention are further illustrated by the following examples. The particular materials and amounts thereof, as well as other conditions and details, recited in these examples should not be used to limit this invention. Rather they are illustrative of the whole invention. Unless stated otherwise all percentages, parts and ratios are by weight. Examples of the invention are numbered while comparative samples, which are not examples of the invention, are designated alphabetically.

### EXAMPLES

The following materials are used in the examples:
NCO-1 is an aromatic diisocyanate, commercially available from The Dow Chemical Company under the trade designation Voranate TDI 80 type I.
CURATIVE-1 is dimethylthiotoluenediamine, commercially available from Albemarle Corporation under the trade designation Ethacure 300,
NOP-1 is a 2000 Mw diol derived from dimer fatty acids, commercially available from Uniqema under the trade designation Priplast 3920.
NOP-2 is a 2000 Mw diol derived from dimmer fatty acids, commercially available from Uniqema under the trade designation Priplast 3900.
POP-1 is a 2000 Mw poly(oxytetramethylene)glycol (PTMEG) diol, commercially available from Invista under the trade designation Terathane 2000.
POP-2 is a 2000 Mw polyester polyol commercially available from The Dow Chemical Company under the trade designation Voralast GF 422.
POP-3 is a 2000 Mw polybutadiene diol commercially available from Sartomer under the trade designation Krasol LBH 2000.
POP-4 is a 4000 Mw PPG diol commercially available from The Dow Chemical Company under the trade designation Voranol EP 1900.
POP-5 is a 2000 Mw PPG diol commercially available from the Dow Chemical Company under the trade designation Voranol 220-056N.
POP-6 is a 1000 Mw poly(oxytetramethylene)glycol (PTMEG) diol, commercially available from Invista under the trade designation Terathane 1000.

### Example 1

A reactor is first charged with 16.93 grams of NCO-1. Under a nitrogen blanket and with agitation supplied by a mechanical stirrer, 100 grams of NOP-1 is added in increments sufficiently small to avoid temperatures exceeding 85° C. from the exothermic reaction. The resulting mixture is maintained at a temperature of about 80° C. under agitation for a period of 5 hours to bring the reaction to completion. The resulting prepolymer has an NCO content of 3.2 percent as determined by ASTM D 5155.

A cast elastomer is prepared by mixing 100 grams of the Prepolymer of Example 1 at 80° C. and 8.57 gram of CURATIVE-1 at room temperature using a mixer commercially available from Hauschild under the trade designation Flacktek Speed Mixer operated at 2200 rpm for 60 seconds. The resulting mixture is then poured into a sheet mold preheated to 100° C. After 45 minutes, the elastomer is demolded and subsequently post cured at 100° C. for 16 hours. The sample is then further conditioned at room temperature for about 4 weeks prior to physical testing, as reported in Table 1.

### Example 2

The procedure of Example 1 is repeated except that NOP-1 is replaced by the same weight of NOP-2. The resulting prepolymer has an NCO content of 3.2 percent.

In making the cast elastomer, the process of Example 1 is followed except that the Prepolymer of Example 1 is replaced by the Prepolymer of Example 2. The resulting elastomer has a hardness of 81 A as determined by the procedure of ASTM D2240, and other physical properties reported in Table 1.

### Comparative Sample A.

The procedure of Example 1 is repeated except that NOP-1 is replaced by the same weight of POP-1. The resulting prepolymer has an NCO content of 3.29 percent

In making the cast elastomer, the process of Example 1 is followed except that the Prepolymer of Example 1 is replaced by the Prepolymer of Comparative Sample A and 7.96 g of CURATIVE-1 are used. The resulting elastomer has hardness of 80 A, and other physical properties reported in Table 1.

### Comparative Sample B

The procedure of Example 1 is repeated except that NOP-1 is replaced by the same weight of POP-2. The resulting prepolymer has an NCO content of 3.35 percent.

In making the cast elastomer, the process of Example 1 is followed except that the Prepolymer of Example 1 is replaced by the Prepolymer of Comparative Sample B and 8.11 g of Curative-1 are used. The resulting elastomer has hardness of 82 A, and other physical properties reported in Table 1.

### Comparative Sample C

The procedure of Example 1 is repeated except that 16.17 g of NCO-1 is used and the NOP-1 is replaced by 30 grams of POP-1, 20 grams of POP-6 and 50 grams of POP-4. The resulting prepolymer has an NCO content of 3.10 percent.

In making the cast elastomer, the process of Example 1 is followed except that the Prepolymer of Example 1 is replaced by the Prepolymer of Comparative Sample C and 7.50 g of CURATIVE -1 are used. The resulting elastomer has hardness of 81 A, and other physical properties reported in Table 1.

### Comparative Sample D

The procedure of Example 1 is repeated except that 17.20 g of NCO-1 is used and the NOP-1 is replaced by 100 grams of POP-3. The resulting prepolymer has an NCO content of 3.3 percent.

In making the cast elastomer, the process of Example 1 is followed except that the Prepolymer of Example 1 is replaced by the Prepolymer of Comparative Sample D and 7.96 g of CURATIVE-1 are used. The resulting elastomer has hardness of 81 A, and other physical properties reported in Table 1.

### Comparative Sample E

The procedure of Example 1 is repeated except that 16.93 g of NCO-1 is used and the NOP-1 is replaced by 100 grams of POP-5. The resulting prepolymer has an NCO content of 3.20 percent.

In making the cast elastomer, the process of Example 1 is followed except that the Prepolymer of Example 1 is replaced by the Prepolymer of Comparative Sample E. and 7.99 g of CURATIVE-1 are used. The resulting elastomer has hardness of 82 A, and other physical properties reported in Table 1.

### Comparative Sample F

The tread is removed from a tire commercially available from Bobcat Company under the trade designation Bobcat 10-16.5 Heavy Duty Skid Steer Tire (hereinafter “Bobcat tire”) and sliced into sample sheets of 2 mm thickness. The sample sheets are then die cut and subjected to physical testing. The results are reported in Table 1.

### Example 3

### A tire

A 120 lb (54.5 kg) sample of the Prepolymer of Example 2 is preheated to 75° C. and loaded to a low pressure, 3-component cast elastomer machine. A 16 lb (7.3 kg) sample of a mixture of CURATIVE-1 and a carbon black pigment commercially available from RRPI LLC under the trade designation Repitan Black 99430 at a ratio of 97:3 by weight is loaded to the machine as chain extenders. The mixing ratio is 100 parts of the prepolymer to 8.00 parts of the chain extender by weight.

The tread is removed from a Bobcat tire to form a rubber carcass. The carcass is subsequently buffed to create a uniform rough surface using a commercial buff equipment. An adhesive commercially available from Pathway Polymer under the trade designation Cilbond 89 is then applied to the buffed carcass. The adhesive is allowed to dry at room temperature for 30 minutes before the carcass is assembled in a Bobcat tire mold and moved to a 100° C. oven. After the mold reaches 100° C., Prepolymer of Example 2 and the chain extender CURATIVE-1 are mixed and dispensed into the mold using a three-component low pressure machine. After the mold is filled, the polyurethane is cured in the 100° C. oven for 45 minutes and then demolded. A tire with a rubber carcass and polyurethane elastomer tread is obtained. The polyurethane treaded tire is then moved to an oven at 100° C. and post cured for 16 hours.

Such polyurethane treaded tires are then mounted on various Bobcat skid steer loaders, such as S150, S300 etc., and evaluated at various job sites, such as construction, farm, and landscape. After 1000 hours of service, minimum tread wear is found for the polyurethane treaded tires, in contrast to the standard rubber treaded Bobcat tires that last only 600-700 hours.

TABLE 1
Properties of Examples 1-2 and Comparative Samples A-F

| Property | CS A | CS B | CS C | CS D | CS E | CS F | Ex 1 | Ex 2 |
|---|---|---|---|---|---|---|---|---|
| Hardness(A) | 80 | 82 | 81 | 81 | 82 | 68 | 82 | 81 |
| Tensile | 5000 | 5270 | 2750 | 2600 | 2400 | 2750 | 3525 | 4045 |
| strength (psi, | | | | | | | | |
| ASTM D 412) | | | | | | | | |
| Elongation | 530 | 640 | 550 | 270 | 640 | 470 | 460 | 530 |
| (%), ASTM | | | | | | | | |
| D412 | | | | | | | | |
| Tear strength | | | | | | | | |
| ASTM D 470, | 63 | 115 | 58 | 58 | 60 | 69 | 102 | 110 |
| pli | | | | | | | | |
| ASTM 624, | 325 | 400 | 314 | 208 | 310 | — | 259 | 318 |
| Die C, pli | | | | | | | | |
| Abrasion | 50 | 42 | 110 | 97 | 165 | 158 | 60 | 50 |
| (mm³), ASTM | | | | | | | | |
| D5963B | | | | | | | | |
| Tg(° C.), | −50 | −26 | −51 | −21 | −50 | −48 | −17 | −36 |
| DMA | | | | | | | | |

1. A prepolymer having active NCO groups which is the reaction product of at least one polyisocyanate and a polyhydric component which comprises at least one dimer fatty derivative diol, that is a natural oil based polyol which includes the derivative of at least one dimer fatty acid.

2. The prepolymer of claim 1 wherein the dimer fatty derivative diol is a dimer fatty acid derivative polyester diol.

3. A polyurethane or polyurea formed from a composition comprising at least one prepolymer which is the reaction product of at least one polyisocyanate and a polyhydric component which comprises at least one dimer fatty derivative diol, that is a natural oil based polyol which includes the derivative of at least one dimer fatty acid.

4. The polyurethane and polyurea of claim 3 wherein the polyurethane or polyurea is an elastomer

5. The polyurethane or polyurea of claim 3 wherein the polyurethane has at least one of the engineering properties, such as abrasion resistance, tear strength, cut/puncture resistance, dynamic performance and mechanical strength at least equal to that of a polyurethane or polyurea formed from the same composition, using the same process, except that the natural oil based polyol is replaced by a conventional polyether polyol having essentially the same molecular weight and functionality.

6. An article comprising at least one polyurethane or polyurea of claim 3.

7. The article of claim 6 wherein the article is at least one sidewall, tire tread, tire, wheel, roller, automotive body part, toy, mechanical part, or insulation.

8. A method for manufacturing a composite rubber tire with a polyurethane tread wherein the composite rubber tire has a rubber carcass with an outer surface and a polyurethane tread, the method comprising the steps of:
(a) treating the outer surface of the rubber carcass;
(b) preparing a polyurethane or polyurea prepolymer; and
(c) mixing the prepolymer with at least one chain extender and applying the mixture to the treated outer surface of the rubber carcass to mold a polyurethane tread.

9. The method of claim 8, wherein the polyurethane or polyurea prepolymer according to step (b) comprises at least a prepolymer composition of claim 1.

10. The method of claim 1, wherein treating an outer surface of a rubber carcass according to step (a) of claim 8 comprises
(a) Buffing the surface of the rubber carcass to create a fresh surface with fine textures;
(b) Coating the rubber carcass with at least one polyurethane or polyurea based adhesive on the fresh, textured surface of the rubber carcass before the polyurethane or polyurea tread is molded on the carcass;
(c) Drying the coating at room temperature for at least 15 minutes, and subsequently vulcanizing the coating at an elevated temperature before molding the polyurethane or polyurea tread on the treated rubber carcass.

11. The method as claimed in claim 1, wherein applying the polyurethane or polyurea prepolymer to the treated outer surface of the rubber carcass to mold the polyurethane or polyurea tread according to step (c) of claim 8 comprises
a. preheating the prepolymer to 70 to 80° C. in an oven;
b. degas the prepolymer under vacuum for at least 5 to 10 minutes to remove entrapped air;
c. inflating the treated rubber carcass to a pressure that is about 50% to 90% of the operating pressure of the tire when it is under normal uses;
d. placing the inflated rubber carcass into a mold and preheating the mold to 100° C. to 130° C.;
e. mixing the prepolymer and at least one chain extender, and pour the mixture into the mold to form the polyurethane or polyurea tread on the outer surface of the rubber carcass while keeping the mold at the set pressure and temperature;
f. demolding the rubber carcass coated with the polyurethane or polyurea tread from the mold after 10 to 60 minutes; and postcuring it at 80° C. to 130° C. for at least 8 hours to obtain a composite rubber tire with a polyurethane or polyurea tread.

12. The method as claimed in claim 8, wherein the low molecular weight chain extender is selected from the group comprising diols, triols, diamines and triamines.

13. A composite rubber tire with a polyurethane tread manufactured in accordance with the method in claim 11.
